(19) United States
(12) Patent Application Publication
(10) Pub. No.: US 2021/0301836 A1
(43) Pub. Date: Sep. 30, 2021

(54) Method and Device for Compressing a Gas

(71) Applicant: Siemens Aktiengesellschaft, München (DE)

(72) Inventors: Vladimir Danov, Erlangen (DE); Florian Reissner, Nürnberg (DE); Jochen Schäfer, Nürnberg (DE)

(73) Assignee: Siemens Aktiengesellschaft, München (DE)

(21) Appl. No.: 17/262,424

(22) PCT Filed: Jul. 17, 2019
(86) PCT No.: PCT/EP2019/069238

§ 371 Date: Jan. 22, 2021

(30) Foreign Application Priority Data
Jul. 24, 2018 (EP) 18185185.8

(51) Int. Cl. F04F 1/02; F04F 1/18

(52) U.S. Cl. CPC F04F 1/02; F04F 1/18

(57) ABSTRACT

Various embodiments of the teachings herein include a method for the compression of a gas comprising: introducing the gas into a compression chamber; pumping a liquid from an intermediate container into the compression chamber; and pumping at least part of the liquid from the compression chamber to a sprinkling system through a sprinkling circuit. The sprinkling system distributes the liquid within the compression chamber.

### CROSS-REFERENCE TO RELATED APPLICATIONS

This application is a U.S. National Stage Application of International Application No. PCT/EP2019/069238 filed Jul. 17, 2019, which designates the United States of America, and claims priority to EP Application No. 18185185.8 filed Jul. 24, 2018, the contents of which are hereby incorporated by reference in their entirety.

### TECHNICAL FIELD

The present disclosure relates to compressed gases. Various embodiments may include methods and/or systems for the compression of a gas

### BACKGROUND

During compression of a gas, the compression energy increases the pressure and the temperature of the gas. If isentropic compression is assumed, the temperature of an ideal gas increases in accordance with

$$T ( p ) = {T}_{0} \cdot {( \frac{p}{{p}_{0}} )}^{( κ - 1 ) / κ} ,$$

where T₀ denotes the temperature before compression, p₀ denotes the pressure before compression, T(p) denotes the temperature after compression, p denotes the pressure after compression and κ denotes the isentropic exponent (adiabatic exponent) of the gas. The temperature increase therefore depends on the temperature before compression, on the pressure ratio, and also on the isentropic exponent.

Compression of a gas (pressure increase) is used in compressed air storage power plants. Here, a gas is compressed by means of electrical energy (electrical power), and the compressed gas is stored by means of a pressurized vessel or of a pressurized subterranean cavern. For subsequent provision of electrical energy, the compressed gas is expanded to regenerate electrical power.

It is advantageous here to maximize the stored proportion of the compression energy used on the gas during compression of same. In typical compressed air storage power plants, that proportion of the compression energy that increases the temperature of the gas is lost. The reason for this is that the gas in the pressurized vessels typically cools to ambient temperature. About 50 percent of the isentropic compression energy is thus lost in the form of heat. The efficiency of compressed air storage power plants is therefore restricted to an efficiency below 50 percent.

Efficiencies above 40 percent are typically achieved only with difficulty.

Adiabatic compressed air storage power plants having higher efficiency are known. However, these have not hitherto been used commercially. In the case of an adiabatic compressed air storage power plant, the heat generated during the compression of the gas is transferred from the compressed gas to a heat transfer medium between individual compression stages and/or after the compression of the gas. During a subsequent expansion of the gas, this heat is transferred back to the gas. Significantly higher efficiency is thus achieved. The challenge posed by this concept consists in essence in its cost-effectiveness. The reason for this is that the indirect heat transfer used here requires large heat transfer means and large heat storage means.

A liquid ring compressor can be used for the compression of a gas. Here, the gas to be compressed is in direct contact with a ring liquid of the liquid ring compressor, and the heat is therefore transferred directly from the gas to the liquid. However, liquid ring compressors have a small heat transfer area. Only a small part of the heat generated during the compression of the gas is therefore actually transferred to the ring liquid (heat transfer medium).

It would be possible to use gases with a small isentropic exponent (ι≈1). This can significantly reduce the heat generated during the compression. However, most of the known gases with small isentropic exponent are expensive, combustible, and/or toxic. Use of these is therefore questionable or subject to significant limitation.

### SUMMARY

The teachings of the present disclosure may be used in methods and/or systems to improve the ability to use heat generated during compression of a gas. For example, some embodiments of the teachings herein include a method for the compression of a gas, where the gas is introduced into a compression chamber (2) for compression of said gas, where a liquid (100) is pumped from an intermediate container (4) into the compression chamber (2) at least partly filled with the gas, where at least part of the liquid (100) is pumped from the compression chamber (2) to a sprinkling system (42) by means of a sprinkling circuit (24), and where distribution of the liquid (100) within the compression chamber (2) is achieved by means of the sprinkling system (42).

In some embodiments, the pumping of the liquid (100) from the intermediate container (4) into the compression chamber (2) is achieved by means of a first pump (31), and where the pumping of the liquid (100) from the compression chamber (2) to the sprinkling system (42) is achieved by means of a second pump (32) of the sprinkling circuit (24).

In some embodiments, after it has reached a threshold pressure, the gas is discharged from the compression chamber (2), and where the discharged gas is stored by means of a pressurized gas storage means (6).

In some embodiments, after the discharge of the gas, the liquid (100) is pumped back into the intermediate container (4) by means of the second pump (32).

In some embodiments, the steps as claimed in the preceding claims are repeated once or more than once until a temperature reached by the liquid (100) within the intermediate container (4) is above a threshold value.

In some embodiments, the threshold value is set above 90 degrees Celsius.

In some embodiments, after reaching the threshold value of its temperature, the liquid (100) is pumped from the intermediate container (4) to a heat storage means (8), and where the heat storage means (8) is at least partly charged by means of the heat that, as a consequence of the compression of the gas, has been absorbed by the liquid (100).

In some embodiments, downstream of the heat storage means (8), the liquid (100) is pumped to a reservoir vessel (10) by means of a third pump (33), and where intermediate storage of the liquid (100) is achieved by means of the reservoir vessel (10).

In some embodiments, at least part of the liquid (100) within the reservoir vessel (10) is pumped from the reservoir vessel (10) by way of the sprinkling circuit (24) to the sprinkling system (42) by means of the second pump (32) and/or of the third pump (33).

In some embodiments, after discharge of the gas from the compression chamber (2) and before storage of said gas by means of the pressurized gas storage means (6), said gas is passed into a first heat exchanger (51), where at least a part of the heat of the discharged gas is transferred to the liquid (100) within the sprinkling circuit (24) by means of the first heat exchanger (51).

In some embodiments, the gas stored by means of the pressurized gas storage means (6) is passed into an expansion turbine (12) for the expansion of the stored gas.

In some embodiments, the gas cooled by means of the expansion is passed into a second heat exchanger (52) of a refrigerant circuit (14) for the cooling of a refrigerant.

In some embodiments, a refrigerant storage means (16) of the refrigerant circuit (14) is charged by means of the refrigeration provided by the refrigerant.

In some embodiments, the first and second pumps (31, 32) are used for the storage of electrical energy in the form of the compressed gas, and where the stored electrical energy is at least partly regenerated by means of a generator coupled to the expansion turbine (6).

As another example, some embodiments include a device (1) for the implementation of a method as claimed in any of the preceding claims, comprising a compression chamber (2) for the compression of a gas, an intermediate container (4) intended to receive a liquid (100), a first pump (31) for the pumping of the liquid from the intermediate container (4) into the compression chamber (2), a sprinkling circuit (24) with a sprinkling system (42) and with a second pump (32), where at least part of the liquid (100) can be pumped from the compression chamber (2) to the sprinkling system (42) by means of the second pump (32), where the liquid (100) pumped to the sprinkling system (42) can be distributed within the compression chamber (2) by means of the sprinkling system (42).

### BRIEF DESCRIPTION OF THE DRAWINGS

Further advantages, features, and details of various embodiments of the teachings herein will be apparent from the working examples described hereinafter, and also from the drawings, which show in diagrammatic form:

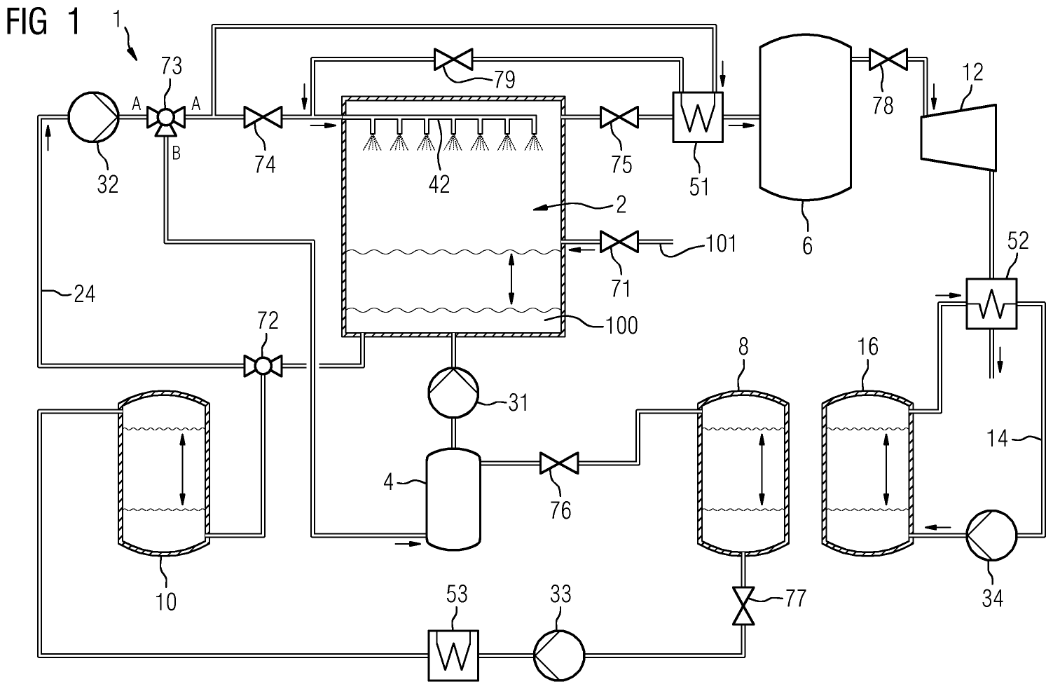

in FIG. 1 a first embodiment of the teachings of the present disclosure; and

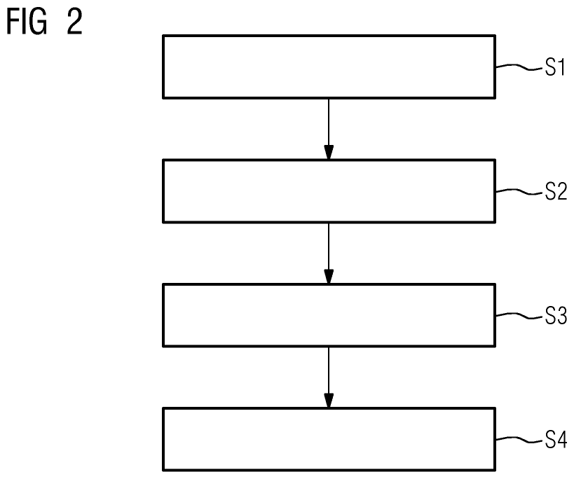

in FIG. 2 a flow diagram of an example method incorporating teachings of the present disclosure.

Elements that are of the same type, are equivalent or have the same effect can have the same reference signs in one of the figures or in both.

### DETAILED DESCRIPTION

In some embodiments, a gas is introduced into a compression chamber for compression of said gas. In some embodiments, the compression chamber here can be a sealed chamber. A liquid is moreover pumped from an intermediate container into the compression chamber at least partly filled with the gas. At least part of the liquid is pumped from the compression chamber to a sprinkling system by means of a sprinkling circuit, where distribution of the liquid within the compression chamber is achieved by means of the sprinkling system.

When heat transfer is mentioned hereinafter, this means at least partial transfer of heat. In particular, complete transfer of the heat is not required.

In some embodiments, the gas is compressed within the compression chamber by means of the liquid pumped into the compression chamber. The reason for this is that the volume available to the gas within the compression chamber is reduced by the pumped introduction of the liquid. A liquid is in particular characterized in that it forms an incompressible fluid. In some embodiments, the liquid is taken from the intermediate container. In other words, the intermediate container comprises the liquid.

In some embodiments, at least part of the liquid is pumped from the compression chamber to a sprinkling system by means of the sprinkling circuit and is distributed by means of the sprinkling system within the compression chamber, in particular sprayed in the form of fine particles, for example in the form of liquid droplets. It is thus made possible to provide a maximized size of heat transfer area between the gas and the liquid within the compression chamber. In other words, heat transfer is provided between the gas and the liquid during compression of said gas. The liquid provided here serves as displacement medium (compression of the gas) as well as a heat transfer medium. In other words, the same liquid is used as displacement medium for the compression of the gas and as heat transfer medium for at least partial absorption of the heat generated during the compression. The heat transfer is made possible by means of the sprinkling circuit and the sprinkling system.

The gas is therefore compressed by means of the liquid by virtue of the reduction of the volume available to the gas. The pressure of the gas within the compression chamber thus increases. The compression chamber has therefore been sealed in the sense that a pressure increase (compression) of the gas is permitted.

The liquid is circulated by means of the sprinkling circuit, i.e. pumped from the compression chamber, in particular from a floor of the compression chamber, to the sprinkling system, and is in turn distributed by means of the sprinkling system in the compression chamber. The distributed liquid is returned to the sprinkling system by means of the sprinkling circuit. A sprinkling circuit for the liquid is thus formed, and the heat here which is generated during the compression of the gas, in direct contact with the liquid, is at least partly transferred to the liquid. Fine spraying of the liquid here by means of the sprinkling system is in particular advantageous.

In some embodiments, the methods permit thermally efficient compression of the gas where the heat generated during the compression is, during direct contact of the materials, at least partly transferred to the liquid simultaneously provided for the compression of the gas. In principle the quantity used of liquid and of gas is not restricted, and it is therefore possible to use a quantity of liquid sufficient for the heat transfer.

In some embodiments, a device comprises at least one compression chamber for the compression of a gas, one intermediate container intended to receive a liquid, one first pump for the pumping of the liquid from the intermediate container into the compression chamber, one sprinkling circuit with a sprinkling system and with a second pump, where at least part of the liquid can be pumped from the compression chamber to the sprinkling system by means of the second pump, and where the liquid pumped to the sprinkling system can be distributed, in particular can be sprayed, particularly preferably can be finely sprayed, within the compression chamber by means of the sprinkling system. Resultant advantages of the devices described herein are similar and equivalent to those of the methods described and/or of one of its embodiments.

In some embodiments, the pumping of the liquid from the intermediate container into the compression chamber is achieved by means of a first pump, and the pumping of the liquid from the compression chamber to the sprinkling system is achieved by means of a second pump. The sprinkling circuit here comprises the second pump. The first pump is therefore configured or intended as compression pump and the second pump is configured or intended as circulating pump for the liquid within the sprinkling circuit. In other words, the liquid is pumped from the intermediate container into the compression chamber by means of the first pump.

The liquid surface level thus rises within the compression chamber, thus compressing the gas within the compression chamber. In other words, the first pump provides at least the compression energy. During the compression of the gas here, heat is typically generated. By means of the second pump, the liquid introduced into the compression chamber is at least partly pumped, for example from the floor of the compression chamber, to the sprinkling system by means of the sprinkling circuit. The liquid thus circulated is distributed, in particular sprayed, within the compression chamber by means of the sprinkling system. The second pump must therefore merely overcome the pressure loss of the sprinkling system and circulates the liquid.

In some embodiments, after it has reached a threshold pressure, the gas is discharged from the compression chamber, where the discharged gas is stored by means of a pressurized gas storage means. In other words, when a defined pressure characterized by the threshold pressure is reached, the compressed gas from the compression chamber is discharged from the compression chamber and stored by means of the pressurized gas storage means. The heat generated during the compression has been at least partly transferred here, in particular in essence completely transferred, to the liquid.

In some embodiments, after the discharge of the gas, the method includes pumping the liquid back into the intermediate container by means of the second pump. In other words, after the compression and discharge of the gas, the liquid is pumped back into the intermediate container by means of the second pump. In an alternative or supplementary procedure, the return of the liquid into the intermediate container can be achieved via a height difference between the compression chamber and the intermediate container. However, this could require excessive amount of time.

In some embodiments, the methods include pumping the liquid back into the intermediate container by means of the second pump, which is comprised by the sprinkling circuit. A valve within the sprinkling circuit can be switched over for this purpose. If during the discharge of the liquid from the compression chamber into the intermediate container a gas supply relating to the gas for the compression chamber is opened, fresh gas is sucked into the compression chamber by virtue of the falling liquid surface level of the liquid within the compression chamber. The original starting situation is thus recreated, and the compression of the gas can be repeated.

In some embodiments, the methods include repeating the compression of the gas to a fresh quantity of gas a number of times until a temperature reached by the liquid within the intermediate container is above a threshold value. The specific heat capacity of liquids, for example water, is typically significantly higher than that of gases, for example air. Although, therefore, a single compression (single cycle) is typically sufficient for the compression of the gas, the liquid here exhibits a small temperature increase. In order to store heat (compression heat) with a sufficient or advantageous temperature it is therefore typically necessary to perform a plurality of cycles. A temperature of the liquid of at least 90 degrees Celsius may be advantageous here. In other words, the threshold value of the temperature is set by way of example at 90 degrees Celsius. It has been found that a temperature of at least 90 degrees Celsius can be reached after about ten cycles, i.e. after ten compressions of the gas and returns of the liquid into the intermediate container. For each new cycle here, fresh gas, i.e. a fresh quantity of the gas, is introduced into the compression chamber. The number of the cycles can depend on the gas used and on the liquid used, i.e. on the pairing of materials.

In some embodiments, after reaching the threshold value of its temperature, the liquid is pumped from the intermediate container to a heat storage means, and the heat storage means is at least partly charged by means of the heat that, as a consequence of the compression of the gas, has been absorbed by the liquid. In some embodiments, the liquid is used directly as heat storage medium of the heat storage means and therefore that the liquid and its heat are stored by means of the heat storage means.

In some embodiments, downstream of the heat storage means, the liquid is pumped to a reservoir vessel by means of a third pump, where intermediate storage of the liquid is achieved by means of the reservoir vessel. In other words, the liquid whose heat has at least partly, in particular to a major extent, in particular completely, been stored by means of the heat storage means is pumped to the reservoir vessel and placed into intermediate storage by means of the reservoir vessel. The reservoir vessel here is provided in order to decouple the repeated compression of the gas and the pumping of the liquid back into the intermediate container from the storage of the heat by means of the heat storage means. The expression “repeated compression of the gas” means resumption of compression using a fresh quantity of the gas. Compression of the same quantity of gas is therefore not repeated. In other words, compression is repeated on a gas of the same description, and not on the same gas. However, it is possible to repeat compression of the same gas.

In some embodiments, at least part of the liquid within the reservoir vessel is pumped from the reservoir vessel by way of the sprinkling circuit to the sprinkling system by means of the second pump and/or by means of the third pump. In other words, the liquid retained in the reservoir vessel is passed into the sprinkling circuit. Residual heat that may be present in the liquid downstream of the heat storage means is thus not lost, but instead is in turn passed into the liquid within the compression chamber by way of the sprinkling system. The heat is therefore retained in the circuit of the liquid. The efficiency of the method in relation to the storage of the heat generated during the compression may be thus improved. The coupling of the reservoir vessel to the sprinkling circuit can be achieved by means of a valve, in particular a three-way valve.

In some embodiments, after discharge of the gas from the compression chamber and before storage of said gas by means of the pressurized gas storage means, said gas is passed into a first heat exchanger, where at least a part of the heat of the discharged gas is transferred to the liquid within the sprinkling circuit by means of the first heat exchanger. Residual heat which is present in the gas and which has not been transferred to the liquid during the compression is thus, after compression of said gas and before storage of said gas, withdrawn by means of the pressurized gas storage means and transferred to the liquid within the sprinkling circuit and, respectively, within the compression chamber. This residual heat is thus transferred to the liquid, thus significantly improving the efficiency of the method.

In some embodiments, the gas stored by means of the pressurized gas storage means is passed into an expansion turbine for the expansion of the stored gas. In other words, the gas stored under pressure is expanded by means of the expansion turbine, thus by way of example generating or providing electrical power by means of a generator coupled to the expansion turbine. It is possible here by virtue of the pressurized gas storage means to provide the electrical power independently of the compression of the gas and of the supply of the electrical power to the first and/or second pump.

In some embodiments, the gas cooled by means of the expansion is passed into a second heat exchanger of a refrigerant circuit for the cooling of a refrigerant. The temperature of the gas expanded by means of the expansion turbine is typically low, in particular below 0 degree Celsius. It is thus possible to provide refrigeration that can be transferred, by means of the second heat exchanger, to a refrigerant circulating within a refrigerant circuit. In some embodiments, the method includes charging a refrigerant storage using the refrigerant circuit using the refrigeration provided by the refrigerant.

The refrigeration transferred to the refrigerant may be stored by means of the refrigerant storage means. In other words, alongside the heat that can be provided by means of the heat storage means, refrigeration is, or can be, likewise provided. It is thus possible to provide refrigeration for a subsequent juncture, and in particular in a manner chronologically decoupled from the compression of the gas.

In some embodiments, the first and second pumps are used for the storage of electrical energy in the form of the compressed gas, where the stored electrical energy is furthermore at least partly regenerated by means of a generator coupled to the expansion turbine. In other words, the method is used for the storage of electrical power. Electrical energy is supplied here to the first and second pump, the gas is compressed, the heat is stored and the compressed gas is stored by means of the pressurized gas storage means.

If electrical power is required at a subsequent juncture, the gas stored by means of the pressurized gas storage means is passed into the expansion turbine, and electrical power is generated by means of the generator coupled to the expansion turbine. It is particularly advantageous here that as a result the expanded gas cools and can in turn be utilized for the charging of a refrigerant storage means. The heat generated during the compression is likewise stored by means of the heat storage means, so that the electrical energy supplied to the pumps is provided or stored in the form of heat, refrigeration and/or electrical energy. In other words, the compression of the gas provides a method for the storage of electrical energy, and also a method for the provision of heat and/or refrigeration.

FIG. 1 is a diagram of a device 1 illustrating an embodiment of teachings of the present disclosure. The device 1 comprises a compression chamber 2 which by way of example is configured as sealed pressurized container. The device 1 moreover comprises an intermediate container 4 (first container), which is configured to accept a liquid 100 or comprises said liquid. The device 1 moreover comprises a sprinkling circuit 24, a sprinkling system 42, a first pump 31 and a second pump 32, an intermediate container 10 (second container), and also a pressurized gas storage means 6.

A gas is first introduced into the compression chamber 2 by means of a gas supply 101. This can be achieved and controlled by means of a valve 71. The liquid 100 is introduced, or pumped, from the intermediate container 4 into the compressor chamber 2 by means of the first pump 31. The pumped introduction of the liquid 100 from the intermediate container 4 into the compression chamber 2 by means of the first pump 31 reduces the volume available to the gas that was introduced. In this sense, the liquid 100 introduced represents a displacement medium in relation to the gas that was introduced. In other words, the pumped introduction of the liquid 100 into the compression chamber 2 compresses the gas that was introduced and thus increases the pressure of the gas.

During the compression of the gas, its temperature typically increases. In other words, the compression energy supplied by means of the first pump 31 is converted into heat and into the compression, i.e. into the pressure increase of the gas. In some embodiments, the sprinkling circuit 24 and of the sprinkling system prevent complete loss of the heat generated during the compression of the gas. The sprinkling, i.e. the distribution, in particular fine spraying, of the liquid 100 within the compression chamber 2 by means of the sprinkling system 42 provides an enlarged heat transfer area between the gas and the liquid 100 within the compression chamber 2. The enlarged heat transfer area significantly improves the heat transfer from the gas to the liquid 100.

By means of the second pump 32, the liquid 100 is circulated within the compression chamber 2 and in turn by means of the sprinkling system 42 is distributed within the compression chamber 2, in particular finely sprayed. The sprinkling circuit 24 here takes the liquid 100 from a floor of the compression chamber 2 and pumps said liquid by means of the second pump 32 to the sprinkling system 42 arranged in the vicinity of an uppermost part of the compression chamber 2. From there, the liquid 100 is distributed, in particular sprayed in the form of fine particles, within the compression chamber 2. The liquid droplets thus produced have an enlarged heat transfer area in relation to the gas, so that the heat transfer from the gas to the liquid 100 is improved. The introduction of the liquid 100 to the sprinkling system 42 can be controlled by means of a fourth valve 74. The sprinkling circuit 24 here comprises the fourth valve 74. The sprinkling circuit 24 moreover has a third valve 73, which during the compression (compression procedure) of the gas has the position or the setting A-A.

Once a defined threshold pressure of the gas has been reached within the compression chamber 2, the gas is discharged from the compression chamber 2 by means of a fifth valve 75 and passed to the pressurized gas storage means 6. By means of the pressurized gas storage means 6 the compressed gas can be stored or placed into intermediate storage for subsequent use.

In order to repeat the compression for a fresh quantity of the gas, the method may include discharging the liquid 100 from the compression chamber 2. For this purpose, the third valve 73 is switched over to the setting A-B. It thus becomes possible, by means of the second pump 32, to pump the liquid 100 from the compression chamber 2, in particular from the floor of the compression chamber 2, back to the intermediate container 4. In some embodiments, the liquid 100 within the compression chamber 2 could flow back to the intermediate container 4 under gravity, for example by virtue of a height difference. However, this procedure is typically too slow, and therefore preference is given to the pumping of the liquid 100 back to the intermediate container 4 by means of the pump 32.

If the first valve 71 of the gas supply 101 is opened during the pumping of the liquid 100 back to the intermediate container 4, the falling liquid surface level within the compression chamber 2 in turn causes a fresh quantity of the gas to be sucked into the compression chamber 2. In other words, the starting situation can thus be recreated—gas within the compression chamber 2 and liquid 100 in the intermediate container 4, not liquid 100 in the compression chamber 2. The fresh quantity of gas can now in turn be compressed by means of pumped introduction of the liquid 100 from the intermediate container 4 into the compression chamber 2 by means of the first pump 31.

A high temperature of the liquid 100 typically requires a plurality of compressions or a plurality of repetitions or cycles. The reason for this is that the specific heat capacity of liquids, for example water, is significantly higher than that of gases, for example air. Although, therefore, a single compression (single cycle) extracts most of the heat from the gas, often an increase in the temperature of the liquid 100 is only small. The number of cycles or compressions required in order to achieve a sufficiently high temperature, for example above 90 degrees Celsius, may depend on the pairing of materials that is typically about ten.

Once a defined high temperature of the liquid 100, for example above 90 degrees Celsius, has been reached, the liquid 100 is passed from the intermediate container 4 to a heat storage means 8 by means of opening of a sixth valve 76. The heat which is present in the liquid 100 and which said liquid has absorbed as a result of the compression of the gas 2 is at least partly stored, or at least partly placed into intermediate storage, by means of the heat storage means 8. The liquid 100 can be used here directly as storage medium for the heat storage means 8. In some embodiments, the heat present in the liquid 100 can be at least partly transferred to a heat storage medium of the heat storage means 8. If the liquid 100 is used directly as heat storage medium within the heat storage means 8, said liquid can be passed into a third heat exchanger 53, for example by means of a seventh valve 77 and by means of a third pump 33, where the heat generated during the compression and stored by means of the liquid 100 is at least partly provided for a heat consumer by means of the third heat exchanger 53.

Downstream of the third heat exchanger 53, the liquid 100 is pumped to a reservoir vessel 10 by means of the third pump 33. By means of the reservoir vessel 10 the liquid 100 is retained for a further use within the sprinkling circuit 24. By way of example, said liquid is passed back into the sprinkling circuit 24 by means of a second valve 72. Residual heat which is present in the liquid 100 and which said liquid retains downstream of the heat storage means 8 or downstream of the third heat exchanger 53 is thus advantageously at least partly reused within the sprinkling circuit 24 and at least partly passed back into said circuit.

By means of a fifth valve 75, the compressed gas is discharged from the compression chamber 2 and passed to the pressurized gas storage means 6. There is a first heat exchanger 51 provided between the compression chamber 2 and the pressurized gas storage means 6. By means of the first heat exchanger 51 it is possible to pass residual heat present in the discharged gas back to the sprinkling circuit 24. The return here can be controlled by means of a ninth valve 79. In other words, residual heat present in the gas is transferred back to the liquid 100 within the sprinkling circuit 24 by means of the first heat exchanger 51. For this purpose, the liquid 100 within the sprinkling circuit 24 can be passed into the first heat exchanger 51 by way of a ninth valve 79. At least partial return of residual heat present in the compressed gas is thus advantageously achieved.

The compressed gas stored by means of the pressurized gas storage means 6 can be passed by means of an eighth valve 78 to an expansion turbine 12, in particular a compressed air turbine, for example with an attached generator. By means of the expansion turbine 12 the compressed gas from the pressurized gas storage means 6 is expanded. By means of the expansion turbine 12 and of the generator it is thus possible to use the expansion energy of the gas to generate and provide electrical energy, i.e. electrical power. The temperature of the gas downstream of the expansion of same is typically low, for example below 0 degree Celsius. This low temperature of the gas can be used to provide refrigeration.

In some embodiments, there is a second heat exchanger 52, thermally coupled to a refrigerant circuit 14. The refrigerant circuit 14 has a refrigerant storage means 16, and also a fourth pump 34, where the fourth pump 34 is intended for the circulation of a refrigerant within the refrigerant circuit 14. The expanded gas is passed into the second heat exchanger 52, where the refrigeration provided by the expanded gas is transferred to the refrigerant circulating within the refrigerant circuit 14 by means of the second heat exchanger 52. The transferred refrigeration is stored by means of the refrigerant storage means 16.

In other words, by means of the depicted embodiment, it is possible to store and/or provide electrical power, heat and/or refrigeration. The device 1 here has high efficiency, in particular above 50 percent, in relation to the electrical energy supplied as input to the pumps 31, 32. Most of the electrical energy relates to the first pump 31, which provides the compression energy of the gas within the compression chamber 2. Electrical energy is likewise provided for the operation of the second pump 32, but the second pump 32 must merely compensate the pressure loss relating to the sprinkling system 42. In other words, the second pump 32 must merely provide circulation energy of the liquid 100.

In some embodiments, particularly effective heat transfer from the gas to be compressed to the liquid 100 is permitted by the sprinkling system 42 and the distribution, in particular fine spraying, of the liquid 100. The liquid 100 here fulfills at least two technical functions. Said liquid is used firstly for the compression of the gas within the compression chamber 2 and secondly for the absorption and, if required, storage of the heat generated during the compression. At least these two technical functions are synergistically combined, thus permitting compression of the gas with maximized effectiveness of the heat transfer between the gas and the liquid 100. The liquid 100 may be water, and the water here can comprise further constituents and/or impurities. The gas is preferably air.

FIG. 2 is a flow diagram of the method. Reference is made here to the elements depicted in FIG. 1. In a first step S1 of the method of the invention for the compression of a gas, the gas is introduced into the compression chamber 2 for compression of said gas. This can be achieved by way of the first valve 71 of the gas supply 101.

In a second step S2, the liquid 100 is pumped from an intermediate container 4 into the compression chamber 2 at least partly filled with the gas. The pumped introduction of the liquid 100 is preferably achieved by means of the first pump 31.

In a third step S3, at least part of the liquid 100 is pumped from the compression chamber 2 to a sprinkling system 42 by means of the sprinkling circuit 24. This can be achieved by means of the second pump 32.

In a fourth step S4, the liquid 100 is distributed, in particular finely sprayed, within the compression chamber 2 by means of the sprinkling system 42.

In a fifth step S5 (not depicted), after a threshold pressure has been reached the gas can be discharged from the compression chamber 2 and stored by means of the pressurized gas storage means 6. The discharge of the gas can be achieved here by means of the fifth valve 75.

In some embodiments, in a sixth step S6 (not depicted), after the discharge of the gas, the liquid 100 is pumped back into the intermediate container 4 by means of the second pump 32. Here, the third valve 73 is switched over from its initial setting A-A to the setting A-B. The liquid 100 is thus pumped from the compression chamber 2 back to the intermediate container 4 by means of the second pump 32.

In some embodiments, in a seventh step S7, during pumping of the liquid 100 back into the intermediate container 4, a fresh quantity of the gas is sucked or introduced into the compression chamber 2 by means of the gas supply 101.

The initial situation as in the first step S1 is thus recreated. In other words, the steps S1 to S6 can be repeated. Compression of the fresh gas is thus achieved (further cycle). The steps S1 to S6 can therefore be repeated one or more times until a temperature of the liquid 100 within the intermediate container 4 above a threshold value is reached. In some embodiments, the threshold value may be above 90 degrees Celsius.

Although the working examples have provided further illustration and description of the teachings herein in detail, the examples disclosed do not restrict the scope thereof, and other variations can be derived by the person skilled in the art therefrom without departing from the scope of disclosure.

### LIST OF REFERENCE SIGNS

1 Device
2 Compression chamber
4 Intermediate container
6 Pressurized gas storage means
8 Heat storage means
10 Reservoir vessel
12 Expansion turbine
14 Refrigerant circuit
16 Refrigerant storage means
24 Sprinkling circuit
31 First pump
32 Second pump
33 Third pump
34 Fourth pump
42 Sprinkling system
51 First heat exchanger
52 Second heat exchanger
53 Third heat exchanger
71 First valve
72 Second valve
73 Third valve
74 Fourth valve
75 Fifth valve
76 Sixth valve
77 Seventh valve
78 Eighth valve
79 Ninth valve
100 Liquid
101 Gas supply
S1 First step
S2 Second step
S3 Third step
S4 Fourth step
S5 Fifth step
S6 Sixth step
S7 Seventh step

What is claimed is:

1. A method for the compression of a gas, the method comprising:
introducing the gas into a compression chamber;
pumping a liquid from an intermediate container into the compression chamber; and
pumping at least part of the liquid from the compression chamber to a sprinkling system through a sprinkling circuit;
wherein the sprinkling system distributes the liquid within the compression chamber.

2. The method as claimed in claim 1, wherein:
a first pump delivers the liquid from the intermediate container into the compression chamber;
a second pump delivers the liquid from the compression chamber to the sprinkling system.

3. The method as claimed in claim 2, further comprising, after reaching a threshold pressure, discharging the gas from the compression chamber; and
storing the discharged gas is stored with a gas storage means.

4. The method as claimed in claim 3, further comprising, after discharging the gas, pumping the liquid back into the intermediate container with the second pump.

5. The method as claimed in claim 4, wherein the elements are repeated until a temperature reached by the liquid within the intermediate container is above a threshold value.

6. The method as claimed in claim 5, where the threshold value is 90 degrees Celsius.

7. The method as claimed in claim 5, further comprising, after reaching the threshold value of its temperature, pumping the liquid from the intermediate container to a heat storage means; and
at least partially charging the heat storage means using the heat that, as a consequence of the compression of the gas, has been absorbed by the liquid.

8. The method as claimed in claim 7, further comprising, downstream of the heat storage means, pumping the liquid to a reservoir vessel using a third pump; and
wherein intermediate storage of the liquid includes the reservoir vessel.

9. The method as claimed in claim 8, further comprising pumping at least part of the liquid within the reservoir vessel is pumped from the reservoir vessel through the sprinkling circuit to the sprinkling system using the second pump and/or the third pump.

10. The method as claimed in claim 1, further comprising, after discharging the gas from the compression chamber and before storing of said gas, passing said gas a first heat exchanger, wherein at least a part of the heat of the discharged gas is transferred to the liquid within the sprinkling circuit using the first heat exchanger.

11. The method as claimed in claim 1, further comprising passing the gas stored in the pressurized gas storage means is into an expansion turbine.

12. The method as claimed in claim 11, further comprising passing the gas cooled the expansion into a second heat exchanger of a refrigerant circuit for cooling a refrigerant.

13. The method as claimed in claim 1, further comprising charging a refrigerant storage n the refrigerant circuit using the refrigerant.

14. The method as claimed in any f claim 11, further comprising: using the first pump and the second pump for storing electrical energy in the form of the compressed gas:
at least partially regenerating the stored electrical energy using a generator coupled to the expansion turbine.

15. A device comprising:
a compression chamber for the compression of a gas;
an intermediate container to receive a liquid;
a first pump for pumping the liquid from the intermediate container into the compression chamber;
a sprinkling circuit with a sprinkling system and a second pump;
wherein at least part of the liquid is pumped from the compression chamber to the sprinkling system using the second pump; and
the liquid pumped to the sprinkling system can be distributed within the compression chamber by the sprinkling system.
